(19) United States
(12) Patent Application Publication
(10) Pub. No.: US 2008/0002415 A1
(43) Pub. Date: Jan. 3, 2008

(54) FASTENING DEVICE WITH SWIVEL BASE

(75) Inventor: Thomas Henkel, Breidenstein (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Polycadform e.K., Breidenstein (DE)

(21) Appl. No.: 11/768,858

(22) Filed: Jun. 26, 2007

(30) Foreign Application Priority Data
Jun. 27, 2006 (DE) 10 2006 029 807.1

(51) Int. Cl. F21V 21/08; F21V 15/01

(52) U.S. Cl. 362/382

(57) ABSTRACT

The invention relates to a fastening device (22) for a housing (21), more preferably lamp housing with at least two connection facility accommodations (27), wherein each of the connection facility accommodations for the accommodation of a spatially positioning fastening device is arranged on a swivel base (23, 24) arranged on the housing in a swiveling manner.

### CROSS-REFERENCE TO RELATED APPLICATIONS

The present patent application claims priority from German Patent Application No. 10 2006 029 807.1, filed on Jun. 27, 2006.

### BACKGROUND OF THE INVENTION

The invention relates to a fastening device for a housing, more preferably lamp housing, with at least two connection facility accommodations, wherein each of the connection facility accommodations are arranged for the accommodation of a spatially positioning fastening device on a swivel base arranged on the housing in a swiveling manner.

The technical area of the invention relates more preferably to the fastening of attachment parts to technical installations, such as for example lamps, which are used for lighting technical installations. More preferably, fastening devices of this type are used for fastening lamps in cabinets or to shelves which are formed of horizontal and vertical profiles or contain these. If profiles are used as fastening base for these housings the profiles are frequently designed as perforated grid profile with a defined hole spacing. Generally, the installation of these housings should take place as quickly and easily as possible and the fastening technique must be easily adaptable to the respective technical conditions.

From the prior art a number of fastening techniques such as for instance screw connections, magnetic holding connections, plug or engagement connections are known in connection with fastening devices of this type. The known fastening devices make possible housing installation in merely one fastening plane, since the fastening device is fixed in its relative position to the housing.

### SUMMARY OF THE INVENTION

The object of the invention is to suggest a fastening device which permits fastening of the housing in different fastening planes or fastening configurations.

This task is solved through a fastening device with the characteristics of claim 1.

The fastening device for a housing according to the invention has at least two connection facility accommodations, wherein each of the connection facility accommodations for accommodating a spatially positioning fastening device is arranged on a swivel base arranged on a housing capable of swiveling. The spatially positioning fastening device serves for the changing of the housing positioning in a fastening plane and the connection of the housing with a fastening base. Through the swivel base arranged in a swiveling manner on the housing the installation of the housing in spatially different fastening configurations is possible in connection with the suitable fastening facilities in each case.

In an advantageous embodiment of the fastening device the fastening facilities can be designed as fastening straps with a fastening bore to establish a bolt connection with a fastening base. With fastening straps of this type, screw, engagement pin or rivet connections with a fastening base can be easily established.

In a further advantageous embodiment the fastening facilities can be designed as fastening straps with a fastening projection for engagement in a fastening base. This enables the insertion or engagement of the fastening straps in through apertures of a fastening base and thus a positive fastening of the housing on the fastening base.

To adapt a housing with a fastening device to a fastening base such as for example a perforated grid profile, the connection facility accommodations of the fastening device can have a guide accommodation for the longitudinally displaceable arrangement of the fastening strap to accommodate a fastening strap. This makes possible the alignment of axially spaced fastening straps to a given hole spacing for the screw connection with or for the engagement in a perforated grid profile.

It is particularly advantageous if the guide accommodation is provided with a grid facility for the relative positioning of the fastening strap. Through the grid facility a fixed setting of two fastening straps arranged at an axial distance from each other to a given perforated grid spacing of a fastening base is possible. Likewise a fixed setting of a fastening projection to a given perforated grid spacing is possible.

It proves to be particularly advantageous if the housing at each of its axial ends is provided with a swivel base for the swiveling of the fastening facilities into a fastening configuration axially protruding the outer housing dimensions. In this way the housing can be arranged with a fastening strap each formed on the swivel base between two perforated grid profiles arranged in parallel to each other such as for instance in a switching cabinet with 19 inch housing accommodations. The fastening straps can be swiveled such that each engages in a through aperture in the perforated grid profile and can be positively inserted through swiveling into an axial position alongside the housing in the through apertures of the perforated grid profiles. In this way the housing can be installed between two perforated grid profiles without additional tools and accessory parts.

If the swivel base is provided with a grid facility for the relative positioning of the fastening facility it is possible through engaging the swivel base on the housing to achieve fixing of the fastening configuration e.g. of the housing between two perforated grid profiles. It further proves advantageous if the swivel base engages in three different positions on the housing. The swivel base for instance can be fixed in a keeping position, in an installation position and in an end position. This facilitates the insertion of the housing between two perforated grid profiles significantly.

### BRIEF DESCRIPTION OF THE DRAWINGS

In the following the invention is explained in more detail making reference to the enclosed drawing.

It shows:

FIG. 1: a housing with a fastening device;

FIG. 2-3: a swivel base for the arrangement capable of swiveling to a housing with two fastening facilities;

FIG. 4-5: a housing in a first fastening configuration;

FIG. 6-7: a housing in a second fastening configuration;

FIG. 8-10: a housing in a third fastening configuration;

### DETAILED DESCRIPTION OF THE INVENTION

In FIG. 1 a lamp 20 with a fastening device 22 arranged on a housing 21 is shown. The fastening device 22 comprises a first swivel base 23 and a second swivel base 24 shown here only schematically. On both swivel bases 23 and 24—as merely shown on the example of the swivel base 23 in FIG. 1—a fastening facility designed as fastening strap 26 is arranged which is accommodated in a connection facility accommodation 27.

The fastening straps are connected with the housing 21 through their arrangement on the swivel bases 23 and 24. In the shown keeping position the fastening strap 26 of the fastening device 22 is not immediately utilizable for installation to a fastening base not shown here.

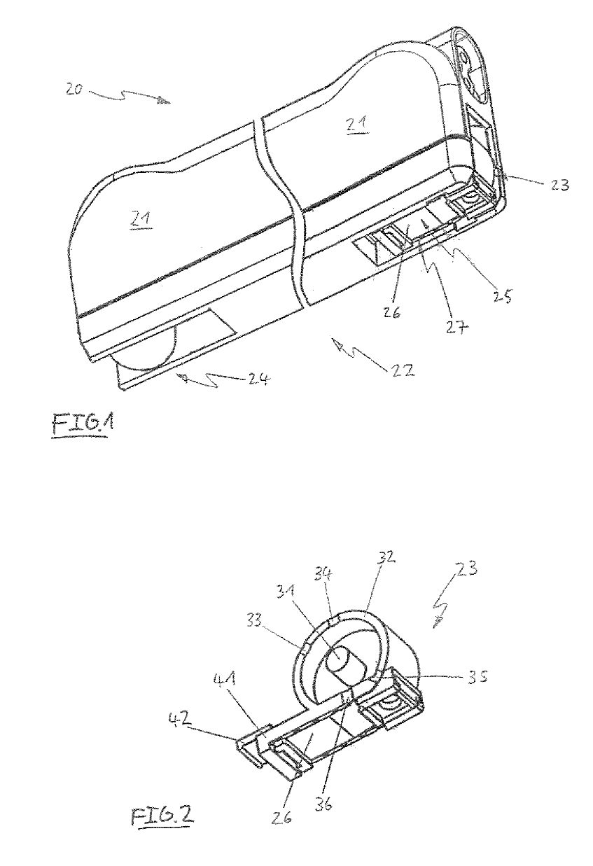

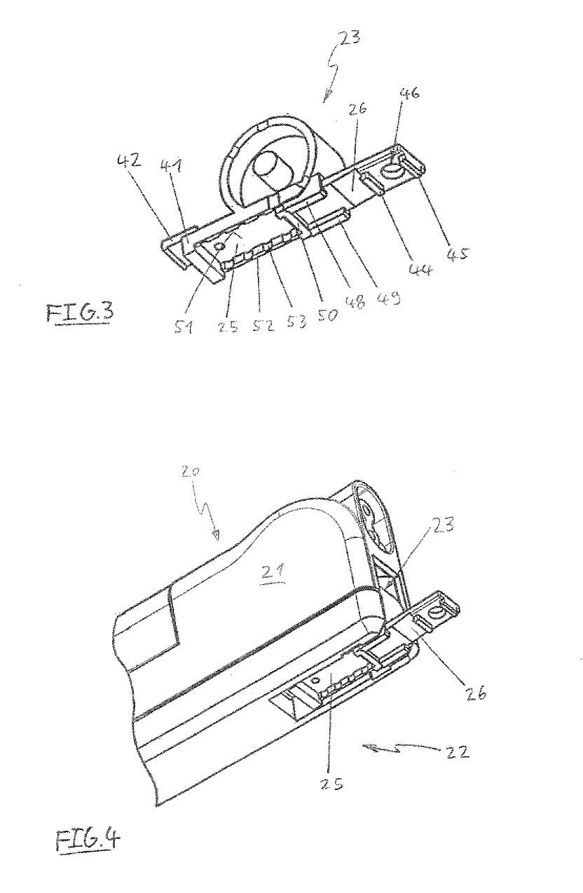

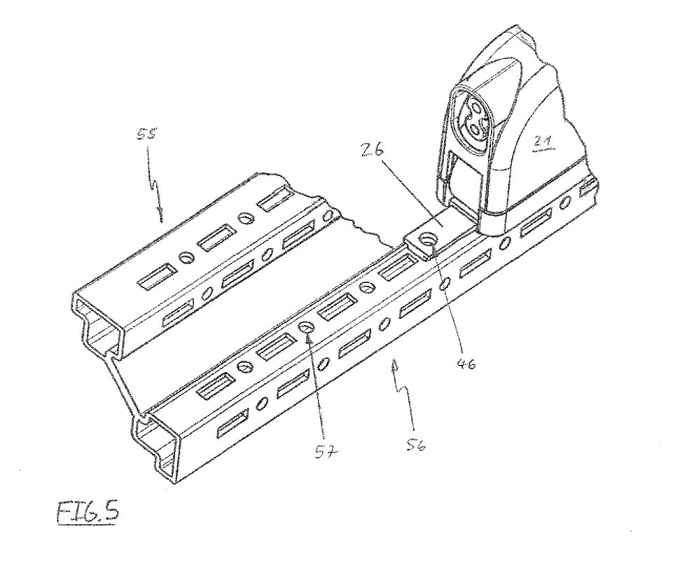

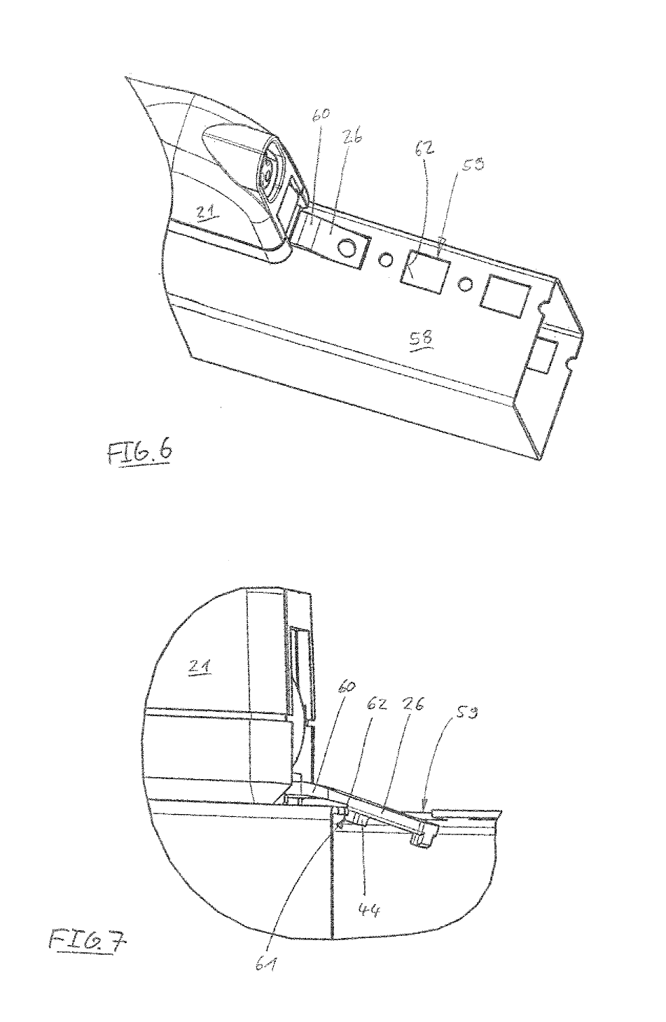

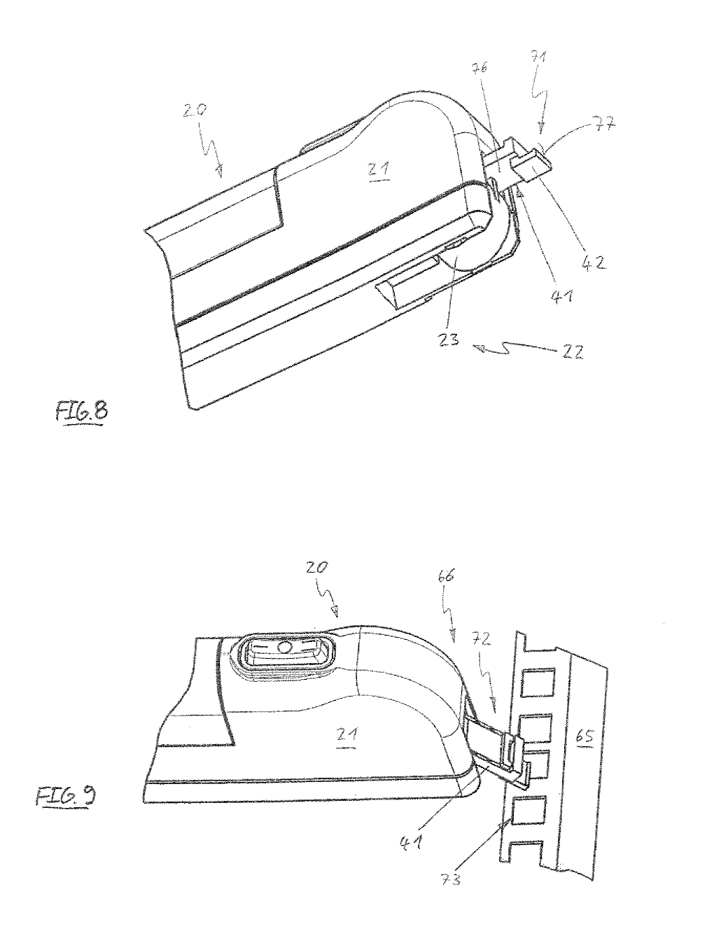

FIG. 2 and 3 show the swivel base 23, on which a swivel shaft 31 is formed, which can be inserted in recesses of the housing not shown here. On an outer largely ring-shaped circumferential body 32 of the swivel base 23, engagement recesses 33, 34, 35 and 36 are formed on its lateral surfaces. The engagement recesses 33, 34, 35 and 36 engage in an engagement lug of a housing not shown here and thus enable fixing of the swivel base 23 relative to the housing 21 in a keeping position, installation position and end position without tools having to be used.

Next to the first fastening strap 26 a second fastening strap 41 is formed on each of the swivel bases 23, 24 which has a fastening projection 42 for insertion into a through hole of a perforated grid profile not shown here. The fastening strap 26 additionally has fastening projections 44 and 45 and a through aperture 46. The fastening projections 44 and 45 with a screw connection with a fastening base not shown here serve as support facility in order to arrange the fastening strap 26 in parallel with the surface of a fastening base. The fastening strap 26 is inserted in the guide accommodation 25 in a longitudinally displaceable manner and secured through guide webs 48, 49 in interaction with a stop 50 against falling out. Lateral surfaces 51, 52 of the guide accommodation 25 are provided with a plurality of engagement recesses 53 in which engagement lugs formed on the fastening strap 26 not shown here, engage. The fastening strap 26 can thus be fixed in a defined position relative to a housing.

FIG. 4 shows a part of a fastening device 22 with the swivel base 23 shown in FIG. 2 and FIG. 3 which is accommodated in the housing 21 and the fastening strap 26 in the guide accommodation 25 in an outer position relative to the housing 21.

Viewing FIG. 4 and FIG. 5 together explains a first possibility of the fastening configuration of the housing 21 on a perforated grid profile 55. On the perforated grid profile 55, profile sections 56 are formed with a multiplicity of through aperture 57. The housing 21 is arranged on the profile section 56 such that the through aperture 46 of the fastening strap 26 is aligned with one of the through apertures of the profile section 56. The housing 21 in this way can be connected via the fastening strap 26 with the perforated grid profile 55 with a bolt, screw or engagement pin connection not shown in more detail here. In addition, the fastening strap 26 through the grid facility shown in FIG. 3 can be adapted to different longitudinal distances of through apertures 57 in the profile section 56.

Viewing FIG. 6 and FIG. 7 together shows a further exemplary embodiment of a fastening configuration between the housing 21 and a perforated grid profile 58. The perforated grid profile 58 is provided with a multiplicity of rectangular through apertures in which the fastening strap 26 can be inserted. The fastening strap 26 is angled in a bending region 60 from its flat extension into an installation position which engages in the through aperture 59. The fastening projection 44 of the fastening strap 26 with an engagement lug 61 formed on said fastening strap engages under an edge 62 of the through aperture 59. In this way the fastening strap 26 engages in the through aperture 59 by means of the engagement lug 61 and makes possible a positive connection of the housing 21 with the perforated grid profile 58.

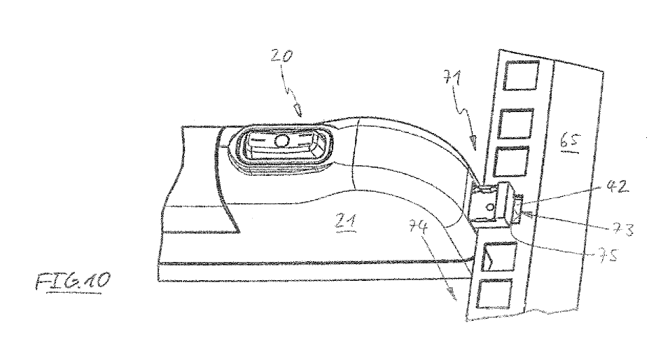

Viewing FIG. 8, FIG. 9 and FIG. 10 together shows a third exemplary embodiment of a fastening configuration of the housing 21 of the lamp 20 with a perforated grid profile 65. A congruent perforated grid profile running parallel with the perforated grid profile 65 follows a housing end not shown here which is located opposite the housing end 66 of the housing 21. The housing 21 is thus accommodated at right angles to the perforated grid profiles in the intermediate space between the perforated grid profiles.

FIG. 8 shows the swivel base 23 inserted in the housing 21 with the fastening strap 41 on which the fastening projection 42 is formed. The fastening strap 41 in the representation shown in FIG. 8 is in an outer end position 71.

FIG. 9 shows the fastening strap 41 in an installation position 72 prior to engagement in a rectangular through aperture 73 of the perforated grid profile 65. An end position 71 of the housing 21 or the fastening strap 41 is achieved through inserting the fastening projection 42 in the through aperture 73 and through a movement of the housing 21 in the direction of the arrow 74, as shown in FIG. 10. The swivel base 23 in this way engages in the housing 21 in the end position 71 through an engagement device not shown here. In addition, the fastening projection 42 on insertion in the through aperture 73 engages behind an edge 75 of the through aperture 73, in this way bracing a lower side 76 of the fastening strap 41 with an upper side 77 of the fastening projection 42, which upon simultaneous engagement of swivel bases 23, 24 respectively accommodated on the housing ends 66 of the housing 21, results in a positive fastening of the housing 21 between the perforated grid profiles 65.

What is claimed:

1. A fastening device for a housing (21) more preferably lamp housing, with at least two connection facility accommodations (27), wherein each of the connection facility accommodations for the accommodation of a spatially positioning fastening device is arranged on a swivel base (23, 24) arranged on the housing in a swiveling manner.

2. The fastening device according to claim 1, characterized in that the fastening facilities are designed as fastening straps (26) with a fastening bore (46) for establishing a bolt connection with a fastening base.

3. The fastening device according to claim 1, characterized in that the fastening facilities are designed as fastening straps (26, 41) with a fastening projection (42, 44, 45) for engagement in a fastening base.

4. The fastening device according to claim 2, characterized in that the connection facility accommodations for accommodating a fastening strap has a guide accommodation (25) for the longitudinally displaceable arrangement of the fastening strap (26).

5. The fastening device according to claim 4, characterized in that the guide accommodation is provided with a grid facility for the relative positioning of the fastening strap.

6. The fastening device according to claim 1, characterized in that the fastening facilities at each of their axial ends (66) of the housing for swiveling the fastening facilities are arranged in a fastening configuration which axially protrudes the outer housing dimensions.

7. The fastening device according to claim 1, characterized in that the swivel base is provided with a grid facility for the relative positioning of the fastening facilities.
